(19) United States
(12) Patent Application Publication
(10) Pub. No.: US 2022/0026839 A1
(43) Pub. Date: Jan. 27, 2022

(54) PRINTER DRIVER WITH OPTION SEARCH FUNCTION

(71) Applicant: Hewlett-Packard Development Company, L.P., Spring, TX (US)

(72) Inventors: Sangmin LEE, Seongnam-si (KR); Jeonghun KIM, Seongnam-si (KR); Jeehee LEE, Seongnam-si (KR); Chaeeun KIM, Seongnam-si (KR)

(21) Appl. No.: 17/299,458

(22) PCT Filed: Mar. 2, 2020
(86) PCT No.: PCT/US2020/020623

§ 371 Date: Jun. 3, 2021

(51) Int. Cl. G03G 15/00; G06F 3/12

(52) U.S. Cl. CPC G03G 15/502; G06F 3/1253; G06F 3/1225; G06F 3/1205; G06F 3/1226; G06F 3/1293

(57) ABSTRACT

An example apparatus for providing a user interface of a printer driver may include a user interface device, a processor, and a memory. The processor, by executing instructions stored in the memory and executable by a computer, is to provide, through a user interface device, a user interface of a printer driver equipped with a search function to search for a print option, display, on the user interface, a print option list including at least one print option corresponding to the user's input, in response to the user's input using the search function, and display, on the user interface, a setting menu corresponding to a print option selected by the user among a plurality of setting menus corresponding to print options, according to a user's selection from the displayed print option list.

### BACKGROUND

A printer driver includes software that converts a print job object prepared by an application program of a host apparatus, such as a computer, to instructions for printer control that may be interpreted by a printer. As printers have different operation methods and functions according to their types and models, different printer drivers are provided according to the types and models of printers. In order to perform a print job using a printer, a printer driver corresponding to the printer is installed on a host apparatus such as a computer. As a universal printer driver (UPD) that is a standard printer driver is provided, the entire printer driver provided to each printer does not need to be installed.

### BRIEF DESCRIPTION OF DRAWINGS

Various examples will be described below by referring to the following figures.

FIG. 1 illustrates a printing environment including an apparatus for providing a user interface of a printer driver and an image forming apparatus according to an example.

FIG. 2 is a block diagram of an apparatus for providing a user interface of a printer driver and an image forming apparatus according to an example.

FIG. 3 is a flowchart of a method of providing a user interface of a printer driver according to an example.

FIG. 4 illustrates a process of searching for a print option in a user interface of a printer driver and exposing, on the user interface, a setting menu corresponding to the print option selected from a print option list according to an example.

FIG. 5 illustrates a print option matching table according to an example.

FIG. 6 illustrates a process of searching for a print option in a user interface of a printer driver based on a print option matching table, and exposing, on a user interface, a setting menu corresponding to a print option selected from a print option list according to an example.

FIG. 7 is a flowchart of searching for a print option in a user interface of a printer driver, and displaying, on a user interface, a print option list including only print options supported by an image forming apparatus according to an example.

FIG. 8 is a flowchart of searching for a print option in a user interface of a printer driver to use a print option that an image forming apparatus does not support, searching for another image forming apparatus that supports the print option, and assigning a found image forming apparatus to be an image forming apparatus to perform a print job according to an example.

FIG. 9 illustrates a process of searching for a print option in a user interface of a printer driver, searching for another image forming apparatus that supports a print option that is not supported by an image forming apparatus, and assigning a found image forming apparatus to be an image forming apparatus to perform a print job according to an example.

FIG. 10 is a flowchart of searching for a print option in a user interface of a printer driver and updating a printer driver when no print option is found according to an example.

FIG. 11 illustrates an update information table according to an example.

### DETAILED DESCRIPTION OF EXAMPLES

In the following description, various examples are described with reference to the accompanying drawings. In the present specification and the drawings, constituent elements having substantially the same functions are referenced by the same reference numerals and thus redundant descriptions thereof may be omitted.

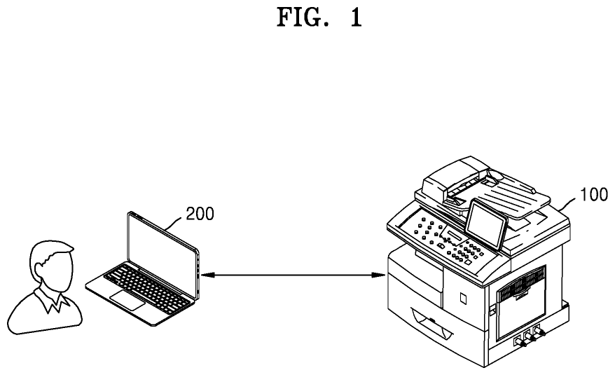

FIG. 1 illustrates a printing environment including an apparatus for providing a user interface of a printer driver and an image forming apparatus according to an example.

Referring to FIG. 1, an image forming apparatus 100, which may be a printer, a copier, a scanner, a facsimile, or a multifunctional device, may perform a print job on a print job object selected or determined by a user. In order for the image forming apparatus 100 to perform the print job, a print job object is transferred in a printable form to the image forming apparatus 100. To this end, a user may execute a printer driver in an apparatus 200 for controlling the image forming apparatus 100. For example, the apparatus 200 may be a host apparatus, such as a computer, to create the print job object in a form that is printable by the image forming apparatus 100 and to transfer the printable form to the image forming apparatus 100.

The apparatus 200 may provide a user interface of a printer driver and may be an apparatus that controls the image forming apparatus 100 or may be included in the apparatus to control the image forming apparatus 100.

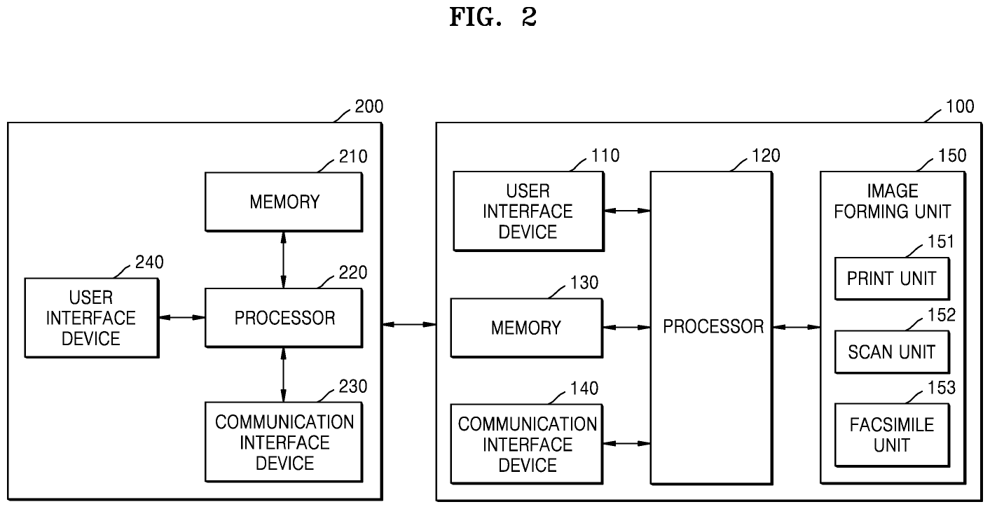

FIG. 2 is a block diagram of an apparatus for providing a user interface of a printer driver and an image forming apparatus according to an example.

Referring to FIG. 2, the image forming apparatus 100 may include a user interface device 110, a processor 120, a memory 130, a communication interface device 140, and an image forming unit 150. Furthermore, although not illustrated, the image forming apparatus 100 may further include a power unit for supplying power to each of the elements.

The user interface device 110 may include an input unit for receiving an input for performing an image forming job from a user and an output unit for displaying information such as a result of the performing of the image forming job or a state of the image forming apparatus 100. The processor 120 may control an operation of the image forming apparatus 100 and may include at least one processing unit such as a central processing unit (CPU). The processor 120 may execute software or a program stored in the memory 130, may read out data or a file stored in the memory 130, or may store a new file in the memory 130. The communication interface device 140 may perform wired or wireless communication with another device or a network. For example, when the communication interface device 140 receives a print instruction signal and a print job object from an external apparatus, the processor 120 may control the received print job object to be output through a print unit 151. Although the image forming unit 150 is illustrated to include the print unit 151, a scan unit 152, and a facsimile unit 153, only some of the above elements may be included as necessary or an element for performing a different type of an image forming job may be further included.

The apparatus 200 for providing a user interface of a printer driver may include a memory 210, a processor 220, a communication interface device 230, and a user interface device 240. The apparatus 200 for providing a user interface of a printer driver may be an apparatus that controls the image forming apparatus 100.

The memory 210 may store instructions that are executable by the processor 220. The memory 210 may store an operating system and application programs. The memory 210 may store a printer driver, which may be a universal printer driver and may be provided together by the operating system.

The processor 220 may execute the instructions stored in the memory 210 to execute the printer driver. The printer driver may perform processing on a print job object so that the image forming apparatus 100 performs a print job. The print job object may be changed to a final form that may be printed by a printer, by sequentially passing through a series of printer filters provided by the printer driver.

The communication interface device 230 may be connected to the image forming apparatus 100 or an external server (not shown) to perform communication with each other. The communication interface device 230 may transmit, to the image forming apparatus 100, a print job object processed by the printer driver in the apparatus 200 for providing a user interface of a printer driver.

The user interface device 240 may include an input unit for receiving a user's input and an output unit for displaying a result of the operation performed by the apparatus 200 for providing a user interface of a printer driver. The user interface device 240 may provide a user interface of a printer driver.

The names of the above-described elements of the image forming apparatus 100 and the apparatus 200 for providing a user interface of a printer driver may vary, and each of the image forming apparatus 100 and the apparatus 200 for providing a user interface of a printer driver may include at least one of the above-described elements, some elements may be omitted, or other additional elements may be further included.

Hereinafter, various examples of setting a print option desired by a user in a user interface of a printer driver so that the apparatus 200 for providing a user interface of a printer driver requests the image forming apparatus 100 to perform a print job are presented below.

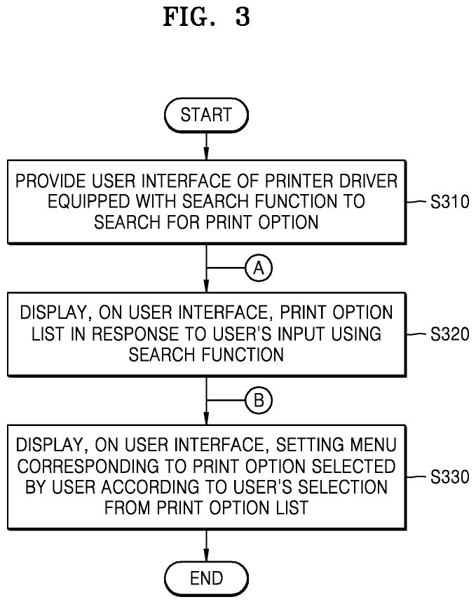

FIG. 3 is a flowchart of a method of providing a user interface of a printer driver according to an example.

Referring to FIG. 3, the apparatus 200 for providing a user interface of a printer driver may provide a user interface of a printer driver equipped with a search function to search for a print option in operation S310. The user interface of a printer driver may include setting menus to set various print options with respect to a print job object before transmitting a print job to the image forming apparatus 100 assigned to perform the print job. As print options supported by the image forming apparatus 100 are diversified and increased with developing technology, a complexity of the user interface of a printer driver may increase and a user may not know all available print options. As the printer driver is equipped with a search function to search for a print option, the user may be assisted to find a desired print option and to directly access a setting menu corresponding to the print option.

The apparatus 200 for providing a user interface of a printer driver may display, on the user interface, in response to an input of the user using the search function, a print option list including at least one print option corresponding to the user's input in operation S320. The apparatus 200 for providing a user interface of a printer driver may interactively display, on the user interface, a print option list including at least one print option corresponding to the user's input, at a location where a user's input is input to a search window.

The apparatus 200 for providing a user interface of a printer driver may display, on the user interface, a setting menu corresponding to the print option selected by the user among the setting menus corresponding to a plurality of print options, according to a user's selection from the displayed print option list in operation S330. In an example, the setting menus corresponding to the print options may be scrolled on the user interface of a printer driver so that the same result as moving to a position of a setting menu corresponding to the print option selected from the print option list may be obtained. The apparatus 200 for providing a user interface of a printer driver may change a corresponding area of the user interface so that a user may directly access a setting menu corresponding to the print option selected by a user from the displayed print option list among the setting menus corresponding to the print options.

When the setting of a print option through the user interface of a printer driver is completed, the apparatus 200 for providing a user interface of a printer driver may create a print job object in a form printable by the image forming apparatus 100, by using a printer driver, and transmit the printable form to the image forming apparatus 100.

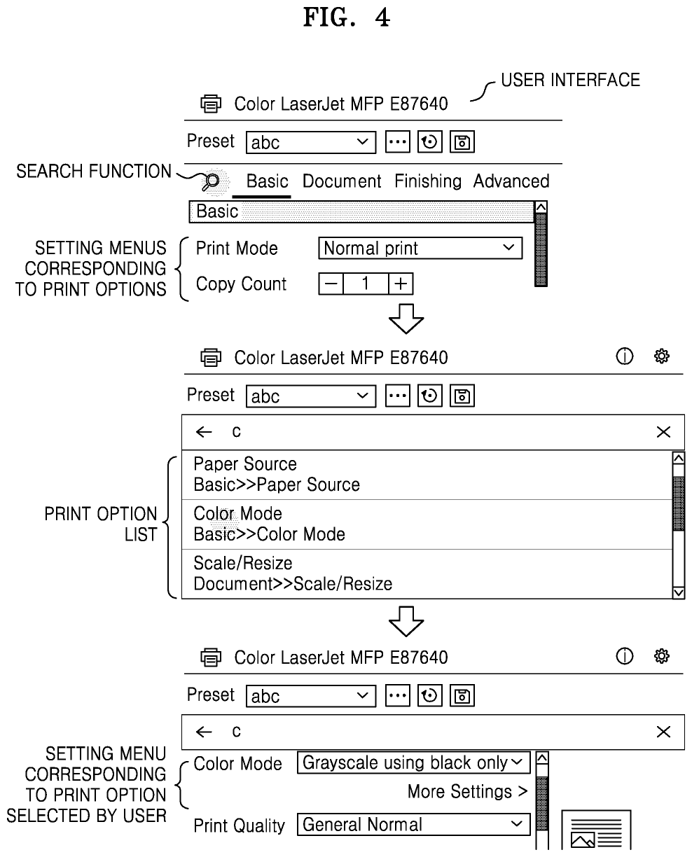

FIG. 4 illustrates a process of searching for a print option in a user interface of a printer driver and exposing, on the user interface, a setting menu corresponding to the print option selected from a print option list according to an example.

Referring to FIG. 4, an example is illustrated in which setting menus for setting print options in a user interface of a printer driver are included. As illustrated in FIG. 4, print options may be classified into categories such as “Basic”, “Document”, “Finishing”, or “Advanced” according to types or attributes thereof. When a user selects a specific category, setting menus corresponding to print options belonging to the specific category may be provided.

In the example of FIG. 4, the category of print options is selected to be “Basic”, and setting menus to select “Print Mode” and “Copy Count” are displayed on the user interface. Setting menus corresponding to print options that are not displayed may be displayed on the user interface by moving a scroll bar at the right side. However, as the order of print options is unknown, it may be inconvenient for a user to scroll until the user finds a desired print option. Moreover, the user may need to continue scrolling until a correct print option appears as it is unclear whether a print option included in the category is correct. Accordingly, the user interface may be provided with a search function to search for a print option.

As illustrated in FIG. 4, when an icon indicating a search function is selected (e.g., clicked), a search window for receiving a user's input may be generated and displayed on the user interface. When “c” is input to the search window as a user's input, in response to the user's input, a print option list including at least one print option corresponding to the user's input may be displayed on the user interface. The at least one print option corresponding to the user's input may be a print option supported by at least one image forming apparatus 100 connected to the apparatus 200 for providing a user interface of a printer driver. For each at least one of the print options in the print option list, a print option list indicating access path information on the user interface or category information of the at least one print option may be displayed on the user interface.

In the example of FIG. 4, a print option list including print options such as “Paper Source”, “Color Mode”, and “Scale/Resize” may be displayed on the user interface in response to the user's input of “c”. Furthermore, for each of print options “Paper Source”, “Color Mode”, and “Scale/Resize”, corresponding access path information of “Basic>>Paper Source”, “Basic>>Color mode”, and “Document>>Scale/Resize” are displayed together in the print option list.

In the example of FIG. 4 in which “Color Mode” is selected by the user's selection in the print option list displayed on the user interface, it may be seen that, instead of a plurality of print options that have been displayed, such as the setting menus corresponding to “Print Mode” and “Copy Count”, a setting menu corresponding to “Color Mode” is displayed on the user interface. Then, the user may directly access the displayed setting menu corresponding to “Color Mode”, complete print option setting, and request printing of the print job object.

As seen from the example of FIG. 4, when the user knows the name of a print option, the user may input the name of a print option in the search window. However, when the user does not know a correct name of a print option, the user may search for the print option based on a print option matching table.

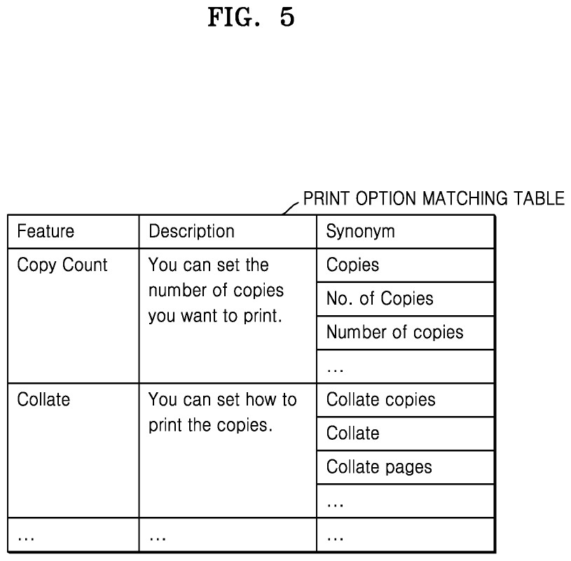

FIG. 5 illustrates the print option matching table according to an example.

Referring to FIG. 5, the print option matching table may store synonyms and descriptions prepared in advance for each print option. For example, when the formal name of a print option is “Copy Count”, various synonyms such as “Copies”, “No. of Copies”, and “Number of copies” and descriptions such as “You can set the number of copies you want to print” may be stored by being matched with each other. Accordingly, even when the user inputs “Number of copies”, not “Copy Count” which is the formal name of a print option, to the search window, as “Number of copies” is a synonym of “Copy Count” based on the print option matching table, a print option list including a print option “Copy Count” may be displayed on the user interface.

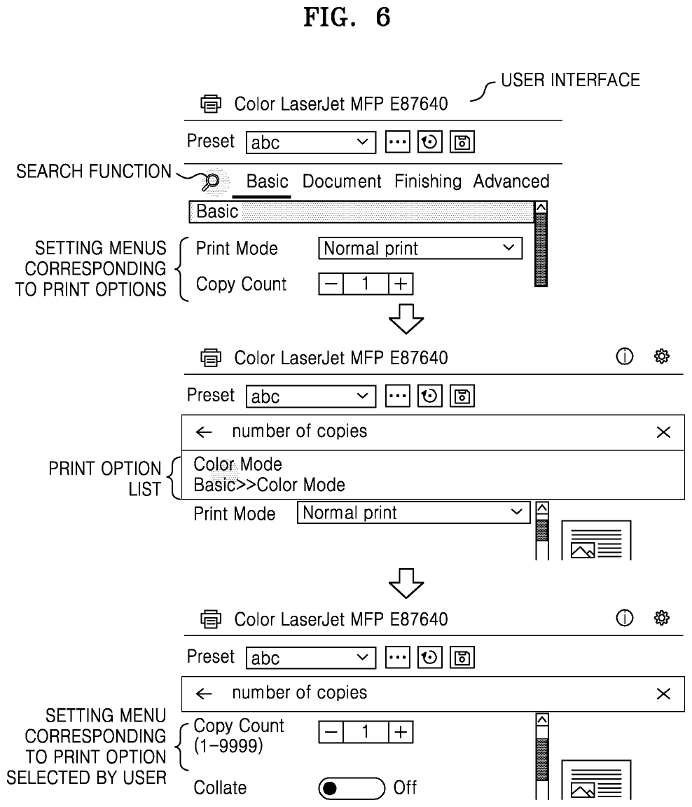

FIG. 6 illustrates a process of searching for a print option in a user interface of a printer driver based on a print option matching table, and exposing, on a user interface, a setting menu corresponding to a print option selected from a print option list according to an example.

Referring to FIG. 6, an example is illustrated in which setting menus corresponding to print options and a search function to search for a print option are provided on the user interface of a printer driver.

The apparatus 200 for providing a user interface of a printer driver may display a print option list including at least one print option corresponding to a synonym that matches a user's input, based on a print option matching table storing synonyms prepared in advance for each print option. Furthermore, the apparatus 200 for providing a user interface of a printer driver may display a print option list indicating at least one print option corresponding to a synonym that matches the user's input and a description together for each at least one print option, based on the print option matching table storing synonyms prepared in advance for each print option and descriptions.

As illustrated in FIG. 6, when an icon indicating a search function is selected by a user (e.g., clicked), a search window for receiving a user's input may be generated and displayed on the user interface. When “number of copies” is input to the search window as a user's input, in response to the user's input, a print option list including a print option corresponding to the user's input may be displayed on the user interface. Referring to FIG. 6, it may be seen that, in response to a user's input of “number of copies”, a print option list including a print option “Copy count” is displayed on the user interface.

As illustrated in FIG. 6, it may be seen that, when “Copy Count” is selected from the print option list displayed on the user interface, a setting menu corresponding to “Copy Count” is displayed at the top end of the user interface. Accordingly, the user may directly access the setting menu corresponding to “Copy Count” that is displayed, complete a print option setting, and request printing of a print job object.

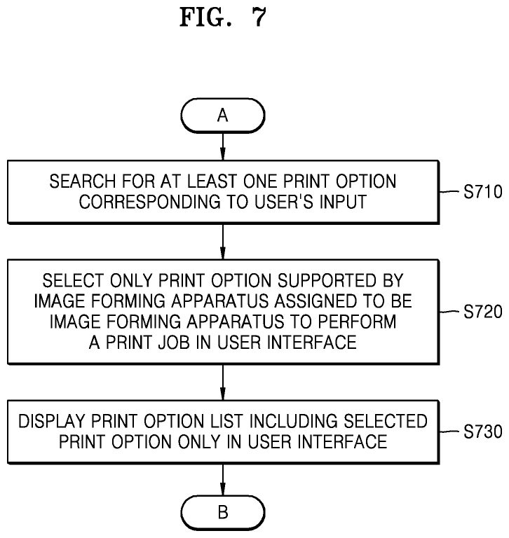

FIG. 7 is a flowchart of searching for a print option in a user interface of a printer driver, and displaying, on a user interface, a print option list including only print options supported by an image forming apparatus according to an example.

Referring to FIG. 7, the apparatus 200 for providing a user interface of a printer driver may search for at least one print option corresponding to a user's input in operation S710.

The apparatus 200 for providing a user interface of a printer driver may select only a print option supported by the image forming apparatus 100 that is assigned to be an image forming apparatus to perform a print job on the user interface, among at least one print option corresponding to the user's input in operation S720.

The apparatus 200 for providing a user interface of a printer driver may display a print option list including the selected print option only on the user interface in operation S730.

Accordingly, only the print options supported by the image forming apparatus 100 that the apparatus 200 for providing a user interface of a printer driver assigned to be an image forming apparatus to perform a print job may be provided as a result of the search to a user. When the user does not intend to perform a print job in an image forming apparatus other than the image forming apparatus 100 that is currently assigned, as a search result is further compressed and provided, user convenience may be provided and a print job may be performed rapidly.

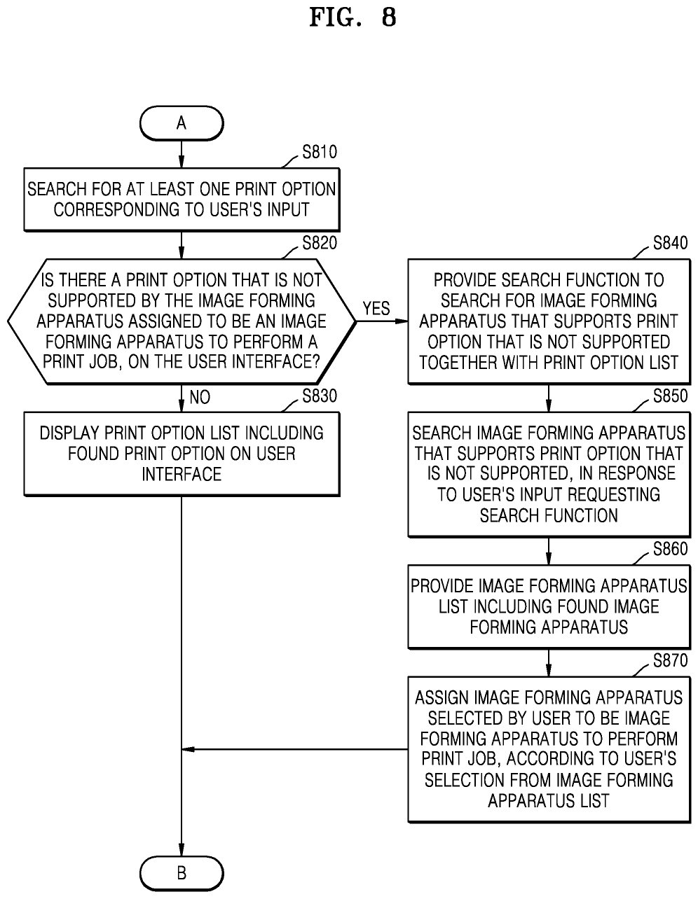

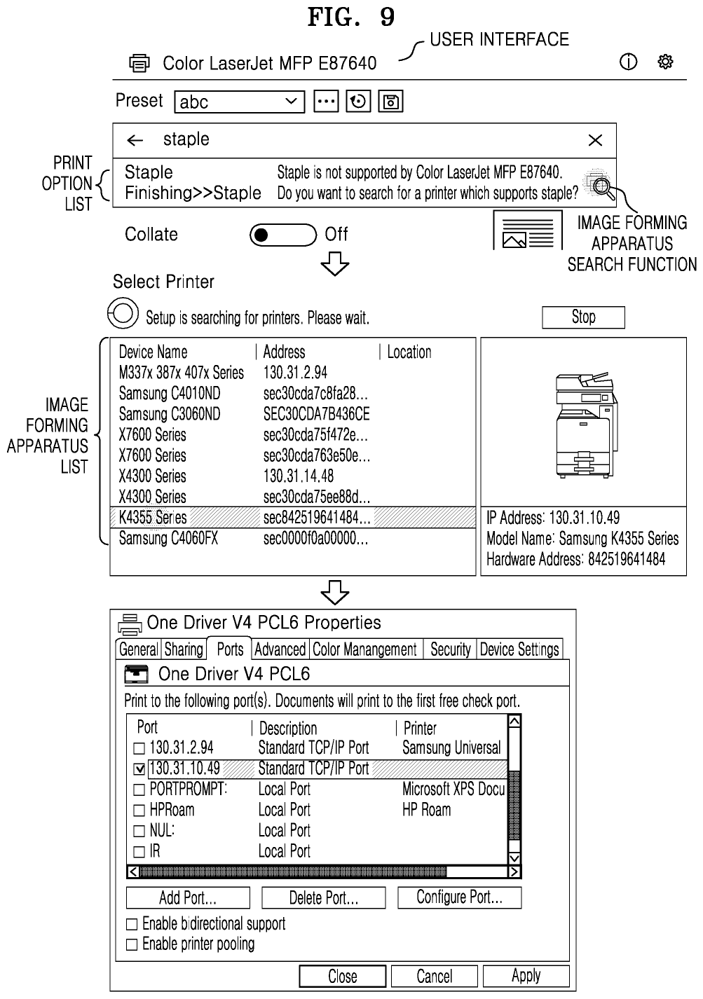

When the image forming apparatus 100 that is assigned to be an image forming apparatus to perform a print job does not support a print option desired by the user, an image forming apparatus that supports the print option desired by the user is searched for, and an image forming apparatus to perform a print job needs to be newly assigned. An example related thereto is described below with reference to FIGS. 8 and 9.

FIG. 8 is a flowchart of searching for a print option in a user interface of a printer driver to use a print option that an image forming apparatus does not support, searching for another image forming apparatus that supports the print option, and assigning a found image forming apparatus to be an image forming apparatus to perform a print job according to an example.

Referring to FIG. 8, the apparatus 200 for providing a user interface of a printer driver may search for at least one print option corresponding to the user's input in operation S810.

The apparatus 200 for providing a user interface of a printer driver may determine whether there is a print option that is not supported by the image forming apparatus 100 assigned to be an image forming apparatus to perform a print job on the user interface, among at least one print option corresponding to the user's input in operation S820.

When there is no print option that is not supported by the image forming apparatus 100 among at least one print option corresponding to the user's input, the apparatus 200 for providing a user interface of a printer driver may display a print option list including a found print option on the user interface in operation S830.

In contrast, where there is a print option that is not supported by the image forming apparatus 100 among at least one print option corresponding to the user's input, the apparatus 200 for providing a user interface of a printer driver may provide a print option list with a search function to search for an image forming apparatus that supports the print option in operation S840.

The apparatus 200 for providing a user interface of a printer driver may search for an image forming apparatus that supports a print option that is not supported by the image forming apparatus 100, in response to a user's input requesting a search function in operation S850.

The apparatus 200 for providing a user interface of a printer driver may provide a list of image forming apparatuses including the found image forming apparatus in operation S860.

The apparatus 200 for providing a user interface of a printer driver may assign an image forming apparatus selected by the user to be an image forming apparatus to perform a print job, according to a user's selection from the provided image forming apparatus list in operation S870.

FIG. 9 illustrates a process of searching for a print option in a user interface of a printer driver, searching for another image forming apparatus that supports a print option that is not supported by an image forming apparatus, and assigning a found image forming apparatus to be an image forming apparatus to perform a print job according to an example.

Referring to FIG. 9 a print option list may be provided on the user interface of a printer driver by using setting menus corresponding to print options and a search function to search for a print option. In the example of FIG. 9, as a result of searching for a print option “staple” by the user, the print option “staple” is provided to a print option list. In the illustrated example, the print option “staple” denotes a print option that is not supported in “MFP E87640” that is assigned to be an image forming apparatus to perform a print job. In this state, a search function to search for an image forming apparatus that supports the print option “staple” may be provided in the form of an icon on the print option list.

As illustrated in FIG. 9, in response to a user's input of selecting the icon corresponding to the search function, an image forming apparatus that supports a print option that is not supported may be searched for and an image forming apparatus list including a found image forming apparatus may be provided. According to a user's selection from the provided image forming apparatus list, an image forming apparatus, “K4355 Series”, which is selected by the user, may be assigned to be an image forming apparatus to perform a print job. As the image forming apparatus “MFP E87640” to perform a print job is replaced with “K4355 Series”, the print option “staple” in the print option list may be changed from an inactive state to an active state, and thus a user's selection may be possible.

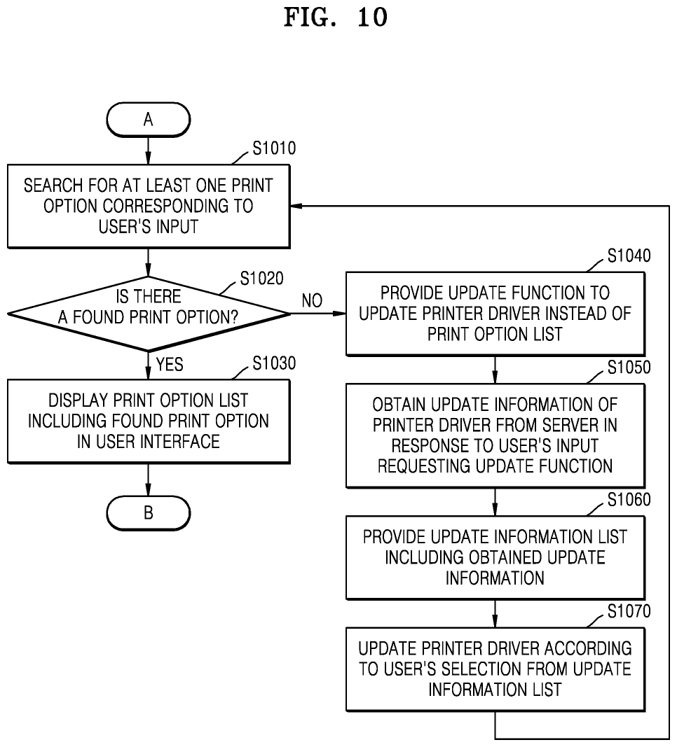

FIG. 10 is a flowchart of searching for a print option in a user interface of a printer driver and updating a printer driver when no print option is found according to an example.

Referring to FIG. 10, the apparatus 200 for providing a user interface of a printer driver may search for at least one print option corresponding to the user's input in operation S1010.

The apparatus 200 for providing a user interface of a printer driver may determine whether there is a found print option in operation S1020.

When a print option corresponding to the user's input is found, the apparatus 200 for providing a user interface of a printer driver may display a print option list including the found print option on the user interface in operation S1030.

In contrast, when no print option corresponding to the user's input is found, the apparatus 200 for providing a user interface of a printer driver may provide an update function to update a printer driver instead of a print option list in operation S1040.

The apparatus 200 for providing a user interface of a printer driver may obtain, in response to a user's input requesting an update function, update information of a printer driver comprising the print option corresponding to the user's input, from a server storing update information of a printer driver in operation 51050. The server storing the update information of a printer driver may have an update information table. The server may check the version of a printer driver installed in the apparatus 200 for providing a user interface of a printer driver, and transmit at least one piece of update information corresponding to a subsequent version to the apparatus 200 for providing a user interface of a printer driver. Alternatively, the server may transmit update information of a printer driver including a print option requested by the apparatus 200 for providing a user interface of a printer driver, to the apparatus 200 for providing a user interface of a printer driver.

The apparatus 200 for providing a user interface of a printer driver may provide an update information list including the obtained update information in operation S1060.

The apparatus 200 for providing a user interface of a printer driver may update the printer driver with updated information selected by the user, according to a user's selection from the provided update information list in operation S1070. As the printer driver is updated, a print option that was not searched for before updating is searched for, and a print option list including a found print option may be displayed on the user interface.

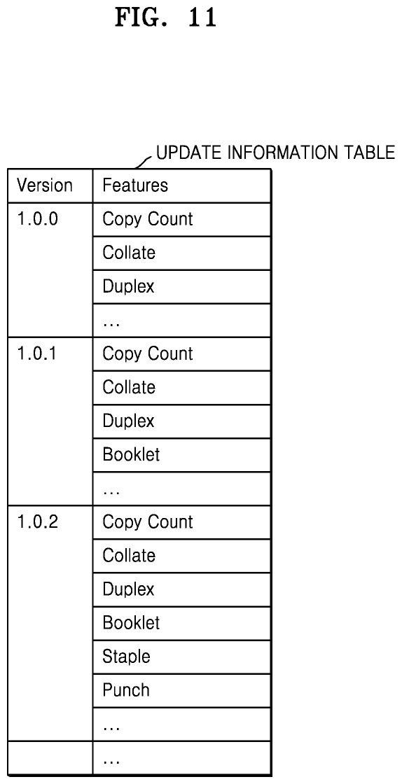

FIG. 11 illustrates an update information table according to an example.

Referring to FIG. 11, an update information table may store update information of various versions including a print option that is not found by the apparatus 200 for providing a user interface of a printer driver. For example, as a print option “Punch” is included in update information of a version “1.0.2”, when the print option “Punch” is found by the apparatus 200 for providing a user interface of a printer driver, a printer driver may be updated by selecting the update information of a version “1.0.2” from an update information list provided by the apparatus 200 for providing a user interface of a printer driver.

Examples regarding the above-described method of providing a user interface of a printer driver may be provided in the form of an application or a computer program stored in a non-transitory computer-readable storage medium to execute each operation of the above-described method in the apparatus 200 for providing a user interface of a printer driver.

The above-described example methods of providing a user interface of a printer driver may be implemented in the form of a non-transitory computer-readable storage medium for storing instructions or data that is executable by a computer or a processor. The examples can be written as computer programs and can be implemented in general-use digital computers that execute the programs using a non-transitory computer-readable storage medium. Examples of the non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storages, optical data storages, hard disks, solid-state disks (SSDs), and instructions or software, related data, data files, and data structures, and any devices capable of providing instructions or software, related data, data files, and data structures to a processor or a computer so that the processor or the computer may execute the instructions may be employed.

What is claimed is:

1. An apparatus for providing a user interface of a printer driver, the apparatus comprising:
a user interface device;
a processor; and
a memory storing instructions executable by the processor,
wherein the processor, by executing the instructions, is to:
provide, through the user interface device, a user interface of a printer driver equipped with a search function to search for a print option,
display, on the user interface, in response to an input of a user using the search function, a print option list including at least one print option corresponding to the user's input, and
display, on the user interface, a setting menu corresponding to a print option selected by the user among a plurality of setting menus corresponding to print options, according to a user's selection from the displayed print option list.

2. The apparatus of claim 1, wherein the at least one print option corresponding to the user's input includes a print option that is supported by at least one image forming apparatus connected to the apparatus for providing a user interface of a printer driver.

3. The apparatus of claim 1, wherein the processor, by executing the instructions, is to display, through the user interface device, the print option list indicating access path information on the user interface or category information of the at least one print option for each at least one print option.

4. The apparatus of claim 1, wherein the processor, by executing the instructions, is to display, through the user interface device, the print option list including the at least one print option corresponding to a synonym matching the user's input, based on a print option matching table storing synonyms for each print option.

5. The apparatus of claim 1, wherein the processor, by executing the instructions, is to display, through the user interface device, the print option list including only print options supported by an image forming apparatus assigned to be an image forming apparatus to perform a print job on the user interface, among the at least one print option corresponding to the user's input.

6. The apparatus of claim 1, wherein the processor, by executing the instructions, is to:
provide, through the user interface device, the print option list together with a search function to search for an image forming apparatus that supports a print option that is not supported by an image forming apparatus assigned to be an image forming apparatus to perform a print job on the user interface, among the at least one print option corresponding to the user's input,
provide an image forming apparatus list including an image forming apparatus that supports a print option that is not supported, in response to a user's input requesting the search function, and
assign an image forming apparatus selected by the user to be an image forming apparatus to perform a print job, according to a user's selection from the provided image forming apparatus list.

7. The apparatus of claim 1, wherein the processor, by executing the instructions, is to:
provide, through the user interface device, an update function to update the printer driver when no print option corresponding to the user's input is found,
provide an update information list including update information comprising a print option corresponding to the user's input, in response to a user's input requesting the update function, the update information list being obtained from a server storing update information of a printer driver, and
update the printer driver with update information selected by the user, according to a user's selection from the provided update information list.

8. A method of providing a user interface of a printer driver, the method comprising:
providing a user interface of a printer driver equipped with a search function to search for a print option;
displaying, on the user interface, in response to an input of a user using the search function, a print option list including at least one print option corresponding to the user's input; and
displaying, on the user interface, a setting menu corresponding to a print option selected by the user among a plurality of setting menus corresponding to print options, according to a user's selection from the displayed print option list.

9. The method of claim 8, wherein
the at least one print option corresponding to the user's input includes a print option that is supported by at least one image forming apparatus connected to the apparatus for providing a user interface of a printer driver.

10. The method of claim 8, wherein
the displaying of the print option list on the user interface comprises displaying the print option list indicating access path information on the user interface or category information of the at least one print option for each at least one print option.

11. The method of claim 8, wherein
the displaying of the print option list on the user interface comprises displaying the print option list including the at least one print option corresponding to a synonym matching the user's input, based on a print option matching table storing synonyms for each print option.

12. The method of claim 8, wherein
the displaying of the print option list on the user interface comprises displaying the print option list including only print options supported by an image forming apparatus assigned to be an image forming apparatus to perform a print job on the user interface, among the at least one print option corresponding to the user's input.

13. The method of claim 8, wherein the displaying of the print option list on the user interface comprises:
providing the print option list together with a search function to search for an image forming apparatus that supports a print option that is not supported by an image forming apparatus assigned to be an image forming apparatus to perform a print job on the user interface, among the at least one print option corresponding to the user's input;
searching for an image forming apparatus that supports a print option that is not supported, in response to a user's input requesting the search function;
providing an image forming apparatus list including the found image forming apparatus, and
assigning an image forming apparatus selected by the user to be an image forming apparatus to perform a print job, according to a user's selection from the provided image forming apparatus list.

14. The method of claim 8, wherein the displaying of the print option list on the user interface comprises:
providing an update function to update the printer driver when no print option corresponding to the user's input is found;
obtaining update information comprising the print option corresponding to the user's input from a server storing update information of a printer driver, in response to a user's input requesting the update function;
providing an update information list including the obtained update information; and
updating the printer driver with update information selected by the user, according to a user's selection from the provided update information list.

15. A non-transitory computer-readable storage medium storing instructions for providing a user interface of a printer driver, the non-transitory computer-readable storage medium comprising:
instructions to provide a user interface of a printer driver equipped with a search function to search for a print option;
instructions to display, on the user interface, a print option list including at least one print option corresponding to the user's input, in response to an input of a user using the search function; and
instructions to display, on the user interface, a setting menu corresponding to a print option selected by the user among a plurality of setting menus corresponding to print options, according to a user's selection from the displayed print option list.
